(19) United States
(12) Patent Application Publication
(10) Pub. No.: US 2006/0289087 A1
(43) Pub. Date: Dec. 28, 2006

(54) Process and system for factory production of pre-oiled wood planks

(76) Inventor: Robert Lachance, Saint Georges (CA)

Correspondence Address: LOWE HAUPTMAN BERNER, LLP, 1700 DIAGONAL ROAD, SUITE 300, ALEXANDRIA, VA, 22314, US

(21) Appl. No.: 10/572,313

(22) PCT Filed: Sep. 17, 2004
(86) PCT No.: PCT/CA04/01695

§ 371 Date: Mar. 17, 2006

(30) Foreign Application Priority Data
Sep. 18, 2003 (CA) 2,442,872

(51) Int. Cl. B27M 1/00

(52) U.S. Cl. 144/380

(57) ABSTRACT

A process and a system for factory production of a pre-oiled wood plank. The wood plank is sand-papered. An impregnating oil coating is applied over the wood plank and then dried. A finishing oil coating is subsequently applied over the wood plank; and then dried before polishing the wood plank.

### FIELD OF THE INVENTION

This invention relates to wood planks processing equipment and more particularly to a process and a system for factory production of pre-oiled wood planks, as used for flooring construction or for covering other surfaces.

### BACKGROUND

Known in the art is U.S. Pat. No. 4,169,005 (Fogle et al.), which discloses a method for surfacing a wood panel with a plastic film. The panel is first sand-papered and successive layers of adhesive coatings are then applied to the surface of the wood panel. The adhesive coatings are dried between each application and then heated-up to activate the adhesive coatings. Finally, a plastic film is applied to the surface of the wood panel and laminated thereto.

Also known in the art is U.S. Pat. No. 4,837,948 (David), which discloses a method and a system for treating a wood surface by using a sand-papered machine and a rotary abrader. The rotary abrader has rollers angularly disposed with respect to each others.

Also known in the art are U.S. Pat. No. 2,343,740 (Birmingham), U.S. Pat. No. 2,601,349 (Welch), U.S. Pat. No. 3,017,287 (Berry et al.), U.S. Pat. No. 3,502,533 (Reiss), U.S. Pat. No. 3,713,935 (Grecchi), U.S. Pat. No. 3,808,032 (Bosco), U.S. Pat. No. 4,113,894 (Koch), U.S. Pat. No. 5,965,207 (Kropfeld et al.), U.S. Pat. No. 6,265,027 (Johnston et al.), and U.S. Pat. No. 6,309,492 (Seidner), which disclose other systems and methods for treating a surface of a wood plank.

However, none of the processes and systems is able to factory produce pre-oiled wood planks, and manual oiling methods are still used despite their slowness and uneven quality.

### SUMMARY OF THE INVENTION

An object of the present invention is to provide a system and a process for factory production of pre-oiled wood planks.

Another object of the present invention is to provide such a system and a process which automate the production of pre-oiled wood planks.

Another object of the present invention is to provide such a system and a process which are adapted to oil high-density wood planks, such as larch, hard maple, silver maple, white ash, oak, etc.

Another object of the present invention is to provide such a system and a process which considerably reduce the manufacturing delays of such pre-oiled wood planks with respect to conventional processes and insure a constant quality for each wood plank.

Another object of the present invention is to provide such a system and a process which allow a standardization of pre-oiled wood planks.

According to the present invention, there is provided a process for factory production of a pre-oiled wood plank, comprising sand-papering the wood plank, applying an impregnating oil coating over the sand-papered wood plank, drying the impregnating oil coating until a first predetermined drying level is reached, applying a finishing oil coating over the wood plank when the impregnating oil coating is dried to said first predetermined drying level, drying the finishing oil coating until a second predetermined drying level is reached, and polishing the wood plank when the finishing oil coating is dried to said second predetermined drying level.

According to the present invention, there is also provided a system for factory production of a pre-oiled wood plank, comprising a sand-papering machine to sand-paper the wood plank, a coater to apply an impregnating oil coating over the sand-papered wood plank, a dryer to dry the impregnating oil coating until a first predetermined drying level is reached, a coater to apply a finishing oil coating over the wood plank when the impregnating oil coating is dried to said first predetermined drying level, a dryer to dry the finishing oil coating until a second predetermined drying level is reached, and a brush to polish the wood plank when the finishing oil coating is dried to said second predetermined drying level.

Preferably, a conveyor system is provided to carry the wood plank through the pre-oiling system and transferring the wood plank between each processing station.

### BRIEF DESCRIPTION OF THE DRAWINGS

These and other objects and advantages of the invention will become apparent upon reading the detailed description and upon referring to the drawings in which:

FIG. 1 is a schematic view of a system for factory production of a pre-oiled wood plank according to the present invention.

FIG. 2 is a schematic view of a matching press according to the present invention.

FIG. 3 is a schematic view of a pattern imprinting roller according to the present invention.

FIG. 4 is a schematic view of a perforated conveyor as used inside an oven according to the present invention.

FIG. 5 is a schematic view of two reverse brushing rollers according to a preferred embodiment of the present invention.

### DESCRIPTION OF PREFERRED EMBODIMENTS

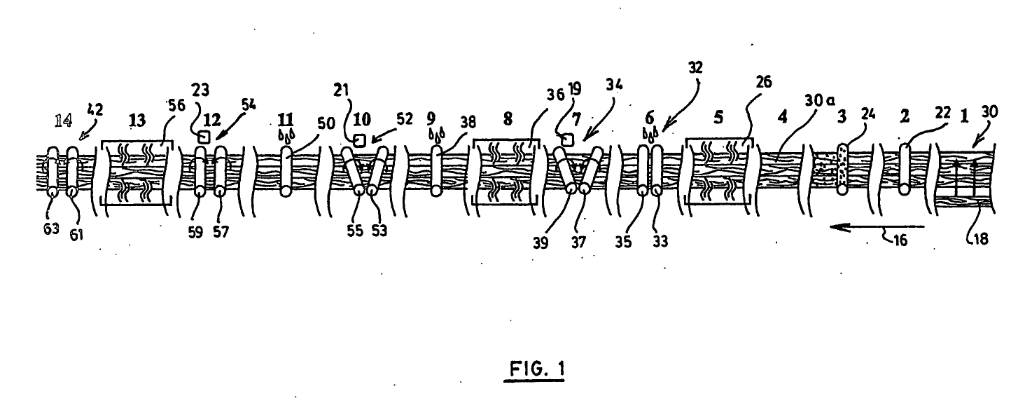

Referring to FIG. 1, there is shown a system for factory production of pre-oiled wood planks 18 according to the present invention. The illustrated system is in the form of an oiling line having a number of processing stations 1-14, some of which may be optional. In practice, a plurality of wood planks 18 will conveniently be treated by the system. A conveyor system 30 may be used to carry the wood planks 18 through the stations 1-14 successively, in a continuous manner. However, depending on the configuration of the system or if desired, the wood planks 18 may be treated one at a time.

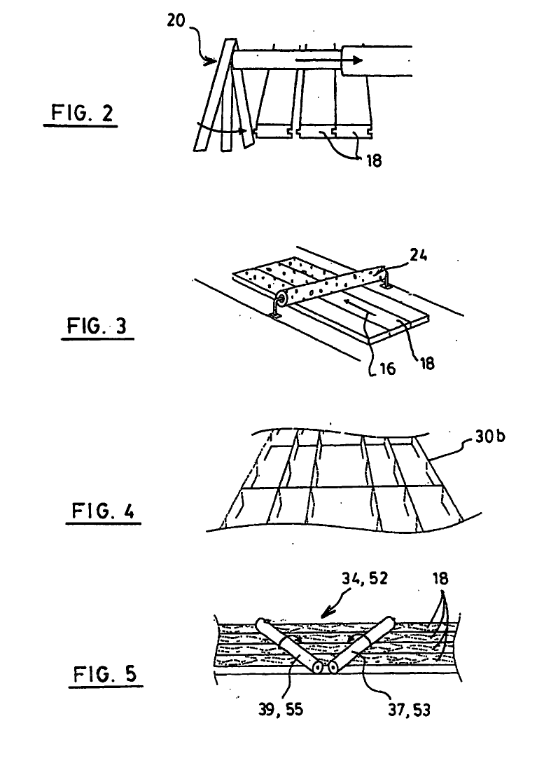

Although wood planks 18 (better shown in FIG. 2) provided with tongue and groove are typically used with the system, other shapes and interlocking arrangements of wood planks can also be accommodated.

At the first station 1, the wood planks 18 are disposed side by side onto the conveyor system 30. The conveyor system 30 carries the wood planks 18 along a transfer course 16 passing by each station. The conveyor system 30 may be made of multiple conveyors or a single one if desired. Since each of the stations 1-14 may have a different processing time, providing independent conveyors 30 for the stations 1-14 may be more convenient. Preferably, a speed of the conveyor system 30 is adjustable.

A matching press 20 may be provided to engage additional wood planks 18 with one another, as shown in FIG. 2. These wood planks 18 are treated together at each of the stations 1-14 to have similar characteristics. For example, after being sand-papered, the woods planks 18 assembled together have approximately the same thickness, thus minimizing disparity between the wood planks 18.

At the second station 2, the wood planks 18 are sand-papered by an automatic sand-papering machine as depicted by abrasive roller 22. The sand-papering machine is preferably adapted to receive different sand-papers whose finishing grains can be selected as a function of the wood species to be processed. The sand-papering machine model 25RRK manufactured by the company HOLITEK can be used for this purpose. The sand-papering machine may also be used to remove possible wood splints and further sand the wood planks 18 if desired.

At the third station 3, the wood planks 18 may be imprinted with a pattern so as to change the finishing of the wood planks 18. This can be done with a sand-papering machine having a pattern imprinting roller 24 positioned to imprint the wood planks 18 as they move along the transfer course 16, as better shown in FIG. 3. The pattern imprinting roller 24 is arranged so that it applies a desired pressure against the surface of the wood planks 18, thereby imprinting the pattern thereto.

The fourth station 4, extending between the sand-papering machine and a heating-up unit 26, may be provided for monitoring a sand-papering quality of the sand-papered wood planks 18. A visual or mechanical inspection of the wood planks 18 may be made as they move on the conveyor system 30a. The conveyor model KYC-063 manufactured by the company HOLITEK can be used to this effect.

The fifth station 5 has a heating-up unit 26 for heating-up the sand-papered wood planks 18 until pores of the wood planks 18 open. The heating-up unit 26 may be made of an infrared oven having a variable speed conveyor and an internal ventilation for circulation of air above and under the wood planks 18. The infrared oven should be able to produce heat at a temperature ranging, from 0 and 200° F. (0 to 94° C.). The pores of the wood planks 18 are opened to promote absorption of oil that will be applied at the next station. Furthermore, the oil coating may dry faster when the pores are opened, thus preventing a coater applying the impregnating oil coating from gumming. As better shown in FIG. 4, the conveyor system 30b inside the heating-up unit 26 may be perforated for uniform drying of the oil coating. The perforated conveyor 30b allows the heated-up air to reach the bottom of the wood planks 18. The infrared oven model KIR-603 manufactured by the company HOLITEK can be used for that purpose.

The heating-up operation may be omitted in the case where there are no additional effects to the pre-oiling process of the wood planks 18, under consideration. In such a case, the fourth station may directly be coupled to the sixth station.

The sixth station 6 has a coater 32 applying an impregnating oil coating over the sand-papered wood planks 18. The coater 32 is preferably a roller coater positioned along the transfer course 16. The roller coater is arranged to come in contact with the surface of the wood planks 18 to apply the impregnating oil coating over the upper surface, the sides and the ends of the wood planks 18. The roller coater may be provided with two rollers 33, 35. The first roller 33 preferably has a maximum hardness of fifteen (15) duro (according to Chor A scale). The first roller 33 performs a first application of the impregnating oil coating while the second roller 35 may be used to perform a second application of oil or to remove oil excess to obtain a uniform oil coating over all the surface of the wood planks 18. The coater model KR2-60 manufactured by the company HOLITEK can be used to this effect.

At the seventh station 7, a brush 34 spreads the impregnating oil coating over the wood planks 18 and an air conditioning unit 19 controls a moisture content of the wood planks 18. Preferably, the air temperature may reach 10° C. Controlling the moisture content may prevent a coater at a following station from gumming. As better shown in FIG. 5, the brush 34 can be provided with two reverse brushing rollers 37, 39 positioned along the transfer course 16 of the wood planks 18. The two reverse brushing rollers 37, 39 may be mounted at different brushing angles with respect to each other to allow the impregnating oil coating to reach imperfections on the surface of the wood planks 18. The rollers 37, 39 are used to spread the oil on the left and right sides, the front, the back and the upper surface of the wood planks 18. The rollers 37, 39 may also conveniently be used to break the bristles possibly remaining after the sand-papering operation of the second and third stations. The application of the impregnating oil coating on the surfaces and the imperfections of the wood planks 18 is thereby uniform so as to obtain a smoother finish. The brush model KRWT-60 manufactured by the company HOLITEK can be used to that purpose.

At the eighth station 8, a dryer 36 dries the impregnating oil coating until a first predetermined drying level is reached. For example, eighty (80) percent (%) of the impregnating oil coating may be dried during the drying operation. Preferably, the dryer may be an oven adapted to receive the wood planks 18. The oven may be provided with a controller to control air temperature within the oven. The air temperature may reach approximately 160° F. The dryer 36 is preferably designed so that air circulates both under and above the wood planks 18. The quick oil drying prevents a coater at the next station from gumming. The conveyor 30b inside the dryer 36 may also be perforated for uniform oil drying, as shown in FIG. 4.

At the ninth station 9, a coater 38 applies a first finishing oil coating over the wood planks 18 when the impregnating oil coating is dried to the first predetermined drying level (e.g. 80%). The coater 38 may be a roller coater positioned along the transfer course 16. The roller coater is arranged so that it comes in contact with the surface of the wood planks 18 when applying the finishing oil coating. The coater model KRN1-60 manufactured by the company HOLITEK can be used to this effect.

At the tenth station 10, a brush 52 spreads the finishing oil coating over the wood planks 18 and an air conditioning unit 21 controls a moisture content of the wood planks 18. Preferably, the air temperature may reach 10° C. Controlling the moisture content may prevent a coater at the next station from gumming. The brush 52 may be provided with the two reverse brushing rollers 53, 55 located along the transfer course 16. The two reverse brushing rollers 53, 55 may be mounted at different brushing angles with respect to each other.

At the eleventh station 11, a coater 50 applies another finishing oil coating after the brushing, as in the ninth station 9. The coater model KRN1-60 manufactured by the company HOLITEK can be used to this effect.

Together, the coaters 33, 35, 38, 50 preferably have an oil applying rate of 0 to 75 g/m². For example, the coaters 33, 35, 38, 50 may have an oil applying rate of 10 g/m² each. The oil applying rate of each of the coaters 33, 35, 38, 50 may vary depending on the species of the wood planks 18.

At the twelfth station 12, a brush 54 spreads the other finishing oil coating in a wood grain direction and an air conditioning unit 23 controls a moisture content of the wood planks 18. Preferably, the air temperature may reach 10° C. Controlling the moisture content may prevent a brush at a following station from gumming. The brush 54 may be provided with two reverse brushing rollers 57, 59 mounted along parallel axes with respect to each other, transversally to the transfer course 16. The machine model KRBW-60 manufactured by the company HOLITEK can be used to this effect.

At the thirteenth station 13, a dryer 56 dries the finishing oil coating until a second predetermined drying level is reached. For example, eighty (80) percent (%) of the finishing oil coating may be dried during the drying operation. The dryer 56 may be an oven adapted to receive the wood planks 18. The oven may be provided with a controller to control air temperature within the oven. The air temperature may reach approximately 160° F. The dryer 56 is preferably designed so that air circulates both under and above the wood planks 18. The conveyor 30b inside the dryer 56 can also be perforated for uniform oil drying, as shown in FIG. 4.

At the fourteenth station 14, a brush 42 polishes the wood planks 18 when the finishing oil coating is dried to the second predetermined drying level (e.g. 80%). The brush 42 may be provided with two reverse brushing rollers 61, 63 positioned along the transfer course 16. The brushing rollers 61, 63 may be mounted along parallel axes with respect with each other, transversely to the transfer course 16. The brush 42 finalizes the finishing of the wood planks 18 which will then be ready for packaging and shipping. Again, the machine model KRBW-60 manufactured by the company HOLITEK can be used to this effect.

It is worth noting that the operations achieved at each station 1 to 14 may be performed more than one time and that other stations may be added for additional processing of the wood planks 18, if desired. For example, two impregnating oil coatings may be applied on the wood planks 18 if desired.

Furthermore, the conveyor system 30 of the pre-oiling system may carry the wood planks 18 in a non linear configuration, such as in a loop back configuration. In a loop back configuration, the wood planks 18 are carried to the same station more than one time for subsequent treatments, if desired. Instead of operating two or more of the same station as shown in FIG. 1 (e.g. the dryers 36, 56), only one station may be used.

To sum up, in the process according to the present invention, the wood plank 18 is sand-papered. Then, an impregnating oil coating is applied over the sands-papered wood plank 18. The impregnating oil coating is dried until a first predetermined drying level is reached. A finishing oil coating is then applied on the wood plank 18 when the impregnating oil coating is dried to the first predetermined drying level. The finishing oil coating is dried until a second predetermined drying level is reached. Then, the wood plank 18 is polished when the finishing oil coating is dried to the second predetermined drying level.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

Furthermore, as previously mentioned, the system and process of the present invention are preferably used for factory production of pre-oiled high-density wood planks, such as larch, hard maple, silver maple, white ash, oak, etc. Of course, the system and the process can be used for factory production of pre-oiled low-density wood planks as well.

Instead of being carried by the conveyor system 30, the wood planks 18 may be stationary. In that case, the system may be provided with devices successively moved over the wood planks 18 for treating them as achieved by the different stations previously described. Such a system could be installed and operated in small environments as opposed to the system with the linear conveyor system 30.

1. A process for factory production of a pre-oiled wood plank, comprising the steps of:
a) sand-papering the wood plank;
b) applying an impregnating oil coating over the sand-papered wood plank;
c) drying the impregnating oil coating until a first predetermined drying level is reached;
d) applying a finishing oil coating over the wood plank when the impregnating oil coating is dried to said first predetermined drying level;
e) drying the finishing oil coating until a second predetermined drying level is reached; and
f) polishing the wood plank when the finishing oil coating is dried to said second predetermined drying level.

2. The process according to claim 1, wherein the sand-papering, applying, drying and polishing are effected by transferring the wood plank between devices.

3. The process according to claim 1, further comprising imprinting a pattern over the wood plank prior to applying the impregnating oil coating.

4. The process according to claim 1, further comprising monitoring a sand-papering quality of the sand-papered wood plank prior to applying the impregnating oil coating.

5. The process according to claim 1, wherein the impregnating oil coating is applied by brushing the wood plank.

6. (canceled)

7. The process according to claim 5, wherein the brushing comprises first and second reverse brushing operations performed along different brushing angles on a surface of the wood plank.

8. (canceled)

9. The process according to claim 1, wherein the finishing oil coating is spread by brushing the wood plank.

10. (canceled)

11. The process according to claim 9, wherein the brushing comprises first and second reverse brushing operations.

12. (canceled)

13. (canceled)

14. The process according to claim 1, wherein the polishing comprises first and second reverse brushing operations performed along parallel axes with respect to each other on a surface of the wood plank.

15. (canceled)

16. The process according to claim 1, wherein the applying of the impregnating oil coating is performed over a top surface, sides and ends of the wood plank and the applying of the finishing oil coating is performed over said top surface, sides and ends of the wood plank.

17. (canceled)

18. The process according to claim 5, further comprising:
applying another finishing oil coating over the wood plank after the brushing; and
brushing the wood plank for spreading the other finishing oil coating in a wood grain direction.

19. The process according to claim 1, wherein the applying of the impregnating oil coating comprises a first application of the impregnating oil coating and then one of a second application of the impregnating oil coating and a removal of oil excess depending on a result of the first application.

20. The process according to claim 1, further comprising engaging additional wood planks with one another and the wood plank prior to the sand-papering.

21. A system for factory production of a pre-oiled wood plank, comprising:
a) a sand-papering machine to sand-paper the wood plank;
b) a coater to apply an impregnating oil coating over the sand-papered wood plank;
c) a dryer to dry the impregnating oil coating until a first predetermined drying level is reached;
d) a coater to apply a finishing oil coating over the wood plank when the impregnating oil coating is dried to said first predetermined drying level;
e) a dryer to dry the finishing oil coating until a second predetermined drying level is reached; and
f) a brush to polish the wood plank when the finishing oil coating is dried to said second predetermined drying level.

22. The system according to claim 21, further comprising a conveyor means for transferring the wood plank along a transfer course passing by the sand-papering machine, the coaters, the dryers and the brush.

23. (canceled)

24. (canceled)

25. The system according to claim 21, further comprising means for spreading the impregnating oil coating over the wood plank, said means comprising an air conditioning unit for controlling a moisture content of the wood plank and two reverse brushing rollers positioned along a transfer course of the wood plank, the two reverse brushing rollers being arranged to come in contact with a surface of the wood plank.

26. (canceled)

27. (canceled)

28. (canceled)

29. The system according to claim 21, further comprising means for spreading the finishing oil coating over the wood plank, said means for spreading the finishing oil coating comprising an air conditioning unit for controlling a moisture content of the wood plank and two reverse brushing rollers positioned along a transfer course of the wood plank, the two reverse brushing rollers being arranged to come in contact with a surface of the wood plank.

30. (canceled)

31. (canceled)

32. (canceled)

33. (canceled)

34. The system according to claim 21, wherein the sand-papering machine has a pattern imprinting roller positioned along a transfer course of the wood plank, the pattern imprinting roller applying pressure against a surface of the wood plank as the wood plank moves along to imprint a pattern thereto.

35. The system according to claim 21, comprising a station extending between the sand-papering machine and the coater applying the impregnating oil coating, for visual inspection of the wood plank.

36. The system according to claim 21, comprising a means for engaging additional wood planks with one another and the wood plank prior to the sand-papering.

37. (canceled)

38. The system according to claim 21, wherein the coater applying the impregnating oil coating comprises a roller coater positioned along a transfer course of the wood plank, the roller coater being arranged to come in contact with a surface of the wood plank to apply the impregnating oil coating thereto and comprising a first roller to apply a first application of the impregnating oil coating and a second roller adapted to apply a second application of the impregnating oil coating and to remove oil excess.

39. (canceled)

40. (canceled)

41. The system according to claim 21, wherein the coater applying the finishing oil coating comprises a roller coater positioned along a transfer course of the wood plank, the roller coater being arranged to come in contact with a surface of the wood plank to apply the finishing oil coating thereto.

42. The system according to claim 21, wherein the brush comprises two reverse brushing rollers positioned along a transfer course of the wood plank, the two reverse brushing rollers being arranged to come in contact with a surface of the wood plank.

43. (canceled)

44. (canceled)

45. The process according to claim 1, wherein said wood plank comprises larch, hard maple, silver maple, white ash or oak wood.

46. The process according to claim 2, wherein the wood plank is transferred between devices with a conveyor.

47. The process according to claim 1, wherein the steps are effected by moving devices for each step successively over the wood planks.
